(19) United States
(12) Patent Application Publication
(10) Pub. No.: US 2002/0107845 A1
(43) Pub. Date: Aug. 8, 2002

(54) Electronic component data sheet retrieving apparatus and electronic component data sheet retrieving method

(76) Inventor: Hiroki Takahashi, Tokyo (JP)

Correspondence Address: Platon N. Mandros, BURNS, DOANE, SWECKER & MATHIS, L.L.P., P.O. Box 1404, Alexandria, VA, 22313-1404, US

(21) Appl. No.: 09/920,652

(22) Filed: Aug. 3, 2001

(30) Foreign Application Priority Data
Feb. 5, 2001 (JP) 2001-28695

(51) Int. Cl. G06F 7/00

(52) U.S. Cl. 707/3

(57) ABSTRACT

An electronic component data sheet retrieving apparatus includes a retrieving unit retrieving and collecting electronic component data sheets from web sites via a network; storing unit storing the collected electronic component data sheets; and control unit searching the storing unit for a data sheet of an electronic component that matches a desired specification input via an input and output unit and causing the input and output unit to output the retrieved electronic component data sheet.

### BACKGROUND OF THE INVENTION

1. 1. Field of the Invention

The present invention generally relates to an electronic component data sheet retrieving apparatus and an electronic component data sheet retrieving method for retrieving an electronic component data sheet required by a designer of electronic equipment.

2. Description of the Related Art

Conventionally, an electronic component having a specification required by a designer of electronic equipment is selected by manual search through a data book provided by a manufacturer of electronic components. Alternatively, Internet web sites of manufacturers are searched successively so as to download necessary electronic component data sheets. The downloaded data sheets are then searched for an electronic component having a required specification.

A disadvantage with the related-art search method is that it takes a relatively long period of time for a designer of electronic equipment to search for an electronic component that meets a required specification.

### SUMMARY OF THE INVENTION

Accordingly, a general object of the present invention is to provide an electronic component data sheet retrieving apparatus and an electronic component data sheet retrieving method in which the aforementioned disadvantage is eliminated.

Another and more specific object is to provide an electronic component data sheet retrieving apparatus and an electronic component data sheet retrieving method with which a required data sheet is made available efficiently.

The aforementioned objects can be achieved by an electronic component data sheet retrieving apparatus comprising: retrieving means retrieving and collecting data sheets of electronic components via a network; storing means storing the data sheets collected by the retrieving means; control means searching the storing means for a data sheet that matches a desired electronic component specification input via an input means and causing an output means to output the retrieved data sheet.

The retrieving means may retrieve and collect the data sheets on a periodical basis.

The storing means may store electronic component data sheets supplied from an external source in addition to the electronic component data sheets collected by the retrieving means.

The control means may cause the output means to output summary sheets constituting the retrieved electronic component data sheet or a portion of the retrieved electronic component data sheet, and cause the output means to output the entirety of the retrieved electronic component data sheet when an associated instruction is given.

The electronic component data sheet retrieving apparatus may further comprise order means placing an order with a component manufacturer for a desired electronic component via the network, based on the retrieved electronic component data sheet.

The aforementioned objects can also be achieved by an electronic component data sheet retrieving method comprising the steps of: retrieving and collecting data sheets of electronic components via a network; inputting a specification of a desired electronic component; searching the collected data sheets for a data sheet of an electronic component that matches the specification of the desired electronic component; and outputting the matching electronic component data sheet.

### BRIEF DESCRIPTION OF THE DRAWINGS

Other objects and further features of the present invention will be apparent from the following detailed description when read in conjunction with the accompanying drawings, in which:

FIG. 1 shows a construction of an electronic component data sheet retrieving apparatus according to a first embodiment of the present invention; and

FIG. 2 is a flowchart showing an electronic component data sheet retrieving method according to the first embodiment.

### DESCRIPTION OF THE PREFERRED EMBODIMENTS

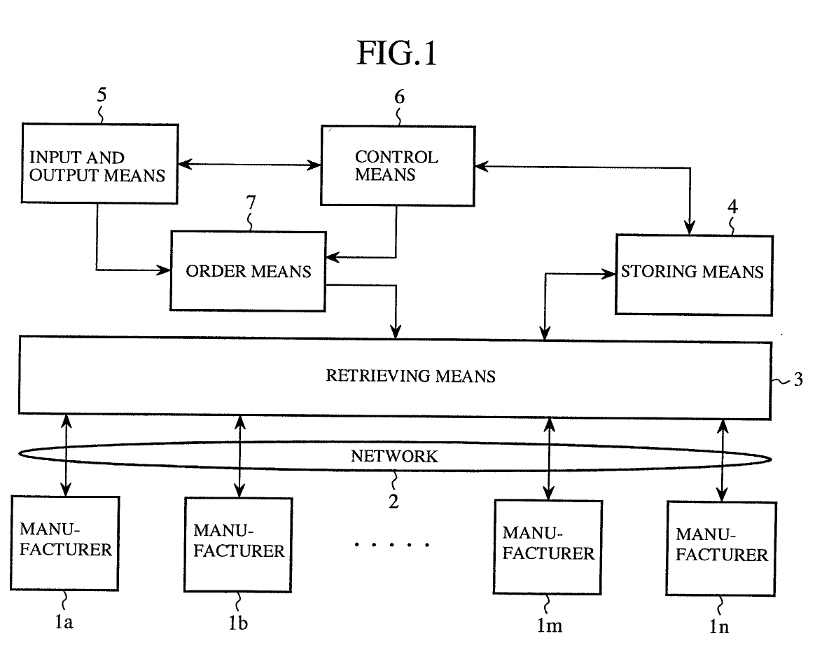

FIG. 1 shows a construction of an electronic component data sheet apparatus according to a first embodiment of the present invention. Referring to FIG. 1, reference numerals 1a-1n denote web sites of manufacturers of electronic components. The data sheets of electronic components are stored in the form of web pages. Reference numeral 2 denotes a network.

Reference numeral 3 indicates a retrieving means periodically visiting the web sites 1a-1n via the network 2 so as to retrieve and collect the data sheets stored in the sites. Reference numeral 4 indicates a storing means storing the data sheets collected by the retrieving means 3. Reference numeral 5 indicates an input and output means constructed of a keyboard, a mouse, a display, a printer and the like receiving an input requesting a desired specification of electronic component from a designer of electronic equipment and outputting an electronic component data sheet that matches the requested specification. Reference numeral 6 indicates a control means converting the desired specification of electronic component input via the input and output means 5 into a searchable format that allows a search in the storage means 4. The control means 6 also searches the storage means 4 for an electronic component data sheet that matches the desired specification and outputting the retrieved data sheet to the input and output means 5.

Reference numeral 7 indicates an order means which will be described later. The retrieving means 3, the storage means 4, the input and output means 5, the control means 6 and the order means 7 constitute the electronic component data sheet retrieving apparatus according to the invention constructed of a personal computer or the like.

A description will now be given of an operation according to the first embodiment.

The retrieving means 3 makes automatic and period visits to designated web sites 1a-1n via the network 2 so as to retrieve and collect electronic component data sheets stored in the web sites 1a-1n. The storage means 4 stores the electronic component data sheets thus collected.

The electronic component data sheets stored in the web sites 1a-1n of the respective electronic component manufacturers may be updated. By causing the retrieving means 3 to collect the electronic component data sheet periodically and substituting the collected data sheets for the existing data sheets in the storing means 4, it is possible to store the latest electronic component data sheets.

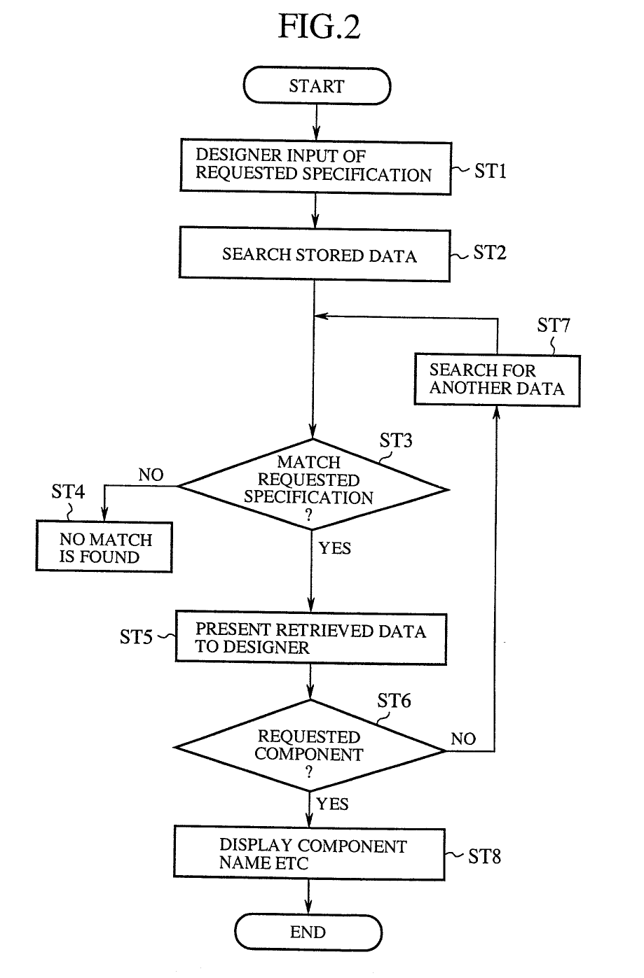

FIG. 2 is a flowchart showing an electronic component data sheet retrieving method according to the first embodiment.

A designer of electronic equipment provides an input requesting a desired specification of electronic component using the input and output means 5 comprising a keyboard or mouse (step ST1: input process). Subsequently, the control means 6 converts the requested specification input via the input and output means 5 into a searchable format that allows a search in the storage means 4 and searches the storage means 4 for a data sheet of an electronic component that matches the requested specification (step ST2: retrieval process). If a data sheet matching the requested specification is not found in the storage means 4 as a result of the search, the control means 6 notifies the input and output means 5 that there is no matching data sheet. The input and output means 5 outputs the notification accordingly using a display or the like included in the input and output means 5 (step ST3, step ST4). If a matching data sheet is found as a result of the search, the control means 6 notifies the input and output means 5 of the matching data sheet so that the input and output means 5 outputs the electronic component data sheet (step ST3, step ST5: output process).

If the designer of electronic equipment viewing the electronic component data sheet displayed by the input and output means 5 determines that a desired electronic component has not been retrieved, the designer uses the keyboard or mouse of the input and output means 5 to indicate that the search was unsuccessful (step ST6). The control means 6 searches the storage means 4 for another data sheet of an electronic component that matches the desired specification (ST7).

The above-described process is repeated until a data sheet of a desired electronic component is retrieved. When the designer of electronic equipment viewing the electronic component data sheet displayed on a display or the like of the input and output means 5 determines that a desired electronic component has been retrieved, the designer uses the keyboard or mouse of the input and output means 5 to display necessary information such as a component name or manufacturer name listed in the data sheet on the display or the like of the input and output means 5 (step ST8). The designer may also uses the keyboard or mouse of the input and output means 5 to produce printout of the retrieved electronic component data sheet using a printer or the like of the input and output means 5.

According to the first embodiment, the retrieving means 3 is configured to search for electronic component data sheet stored in the web sites 1a-1n in a periodic and automatic manner. When a time for update of data sheets from an electronic component manufacturer is known, the retrieving means 3 may be configured to make a search at the expected time according to the setting provided by a designer of electronic component. With this, it is possible to collect and store the latest electronic component data sheet more efficiently than when a simple periodical search is made.

When the number of pages listing electronic component data sheets in any of the web sites 1a-1n is known, the designer of electronic equipment may be given an option for setting the number of pages subject to search by the retrieving means 3, based on the known number of pages. With this, electronic component data sheets can be collected more efficiently than when a simple search is made.

The retrieving means 3 may also provided with a function that allows an electronic equipment designer to perform a manual search in addition to the automatic search capability. With this, electronic component data sheets can be collected and stored more efficiently.

According to the first embodiment, a designer of electronic equipment need only input a desired electronic component specification via the input and output means 5 in order to output a data sheet of electronic component that matches the specification. Thus, a data sheet for desired electronic component is made available efficiently without undue efforts.

Electronic component data sheets are periodically collected as they are updated in the web sites 1a-1n so that the storing means 4 maintains the latest electronic component data sheets available for the designer of electronic equipment to use.

### Second Embodiment

In the first embodiment, the storing means 4 only stores electronic component data sheets collected by the retrieving means 3. In the second embodiment, the storing means 4 stores electronic component data sheets supplied by an electronic component manufacturer via the network 2 or electronic component data sheets supplied by an electronic component manufacturer in the form of an external medium like a floppy disk.

With this, not only the electronic component data sheets collected by the collecting means 3 but also the electronic component data sheets supplied from an external source are made available to the electronic equipment designer, thereby extending a range of selection of electronic components.

### Third Embodiment

In the first embodiment, the control means 6 is configured to cause the input and output means 5 to output the entirety of an electronic component data sheet when the electronic component listed in the data sheet matches the requested specification.

An electronic component data sheet may be several hundred pages in length. Outputting the entirety of an electronic component data sheet at a time via the input and output means 5 is inefficient especially considering the fact that the data sheet may turn out useless according to the judgement of the designer of electronic equipment.

According to the third embodiment, the control means 6 is configured to cause a display or the like of the input and output means 5 to output only those sheets carrying a summary of data sheets of electronic components that match a requested specification.

When it is determined by the electronic equipment designer that a desired electronic component is retrieved, the designer uses the keyboard or mouse of the input and output means 5 to request the output of the entirety of the sheet. When the output of the entirety of the sheet is requested, the control means 6 causes the entirety of the sheet to be output on the display or the like of the input and output means 5.

With this, the electronic equipment designer can cause the entirety of a necessary electronic component data sheet to be output after checking a sheet carrying a summary. It is thus possible to efficiently determine whether a data sheet of a desired electronic component has been retrieved and avoid outputting unnecessary electronic component data sheets.

In the third embodiment, only those sheets carrying a summary of the electronic component data sheet are output via the input and output means 5. When a sheet carrying a summary is absent in the electronic component data sheet, those sheets analogous to a summary sheet are output on a display or the like of the input and output means 5.

### Fourth Embodiment

Referring to FIG. 1, reference numeral 7 indicates an order means that enables placing an order for a desired electronic component from an associated manufacturer via the network 2, based on the electronic component data sheet retrieved by the retrieving means 6.

A description will now be given of the operation according to the fourth embodiment.

As described in the first embodiment, when the electronic equipment designer viewing the electronic component data sheet displayed on a display or the like of the input and output means 5 determines that a desired electronic component has been retrieved, the designer uses the keyboard or mouse of the input and output means 5 to display necessary information carried on the data sheet such as a component name or component manufacturer on the display or the like (step ST8).

In the fourth embodiment, the electronic component designer wishing to place an order for a desired electronic component uses the keyboard or mouse of the input and output means 5 to designate an associated component name carried on the electronic component data sheet displayed on the display or the like of the input and output means 5 so the order is placed.

The order means 7 identifies an address of a component manufacturer with which the order should be placed by referring to the electronic component data sheet retrieved by the retrieving means 6. The order means 7 then places the order with the manufacturer via the network 2, by designating the component name of the desired electronic component.

As described, the fourth embodiment provides an advantage in that an electronic component designer can place an order for a desired electronic component that matches the specification with an associated component manufacturer, based on the data sheet. Thus, it is possible to place an order efficiently. Thus, an order for a desired electronic component can be placed efficiently without undue efforts.

The present invention is not limited to the above-described embodiments, and variations and modifications may be made without departing from the scope of the present invention.

What is claimed is:

1. An electronic component data sheet retrieving apparatus comprising:
retrieving means retrieving and collecting data sheets of electronic components via a network;
storing means storing the data sheets collected by said retrieving means;
control means searching said storing means for a data sheet that matches a desired electronic component specification input via an input means and causing an output means to output the retrieved data sheet.

2. The electronic component data sheet retrieving apparatus according to claim 1, wherein said retrieving means retrieves and collects the data sheets on a periodical basis.

3. The electronic component data sheet retrieving apparatus according to claim 1, wherein said storing means stores electronic component data sheets supplied from an external source in addition to the electronic component data sheets collected by said retrieving means.

4. The electronic component data sheet retrieving apparatus according to claim 1, wherein said control means causes the output means to output summary sheets constituting the retrieved electronic component data sheet or a portion of the retrieved electronic component data sheet, and causes the output means to output the entirety of the retrieved electronic component data sheet when an associated instruction is given.

5. The electronic component data sheet retrieving apparatus according to claim 1, further comprising order means placing an order with a component manufacturer for a desired electronic component via the network, based on the retrieved electronic component data sheet.

6. An electronic component data sheet retrieving method comprising the steps of:
retrieving and collecting data sheets of electronic components via a network;
inputting a specification of a desired electronic component;
searching the collected data sheets for a data sheet of an electronic component that matches the specification of the desired electronic component; and
outputting the matching electronic component data sheet.
